(19) United States
(12) Patent Application Publication
(10) Pub. No.: US 2026/0179953 A1
(43) Pub. Date: Jun. 25, 2026

(54) Cathode and method for producing the same

(71) Applicant: Karlsruher Institut für Technologie, Karlsruhe (DE)

(72) Inventors: Wilhelm Pfleging, Linkenheim (DE); Peter Smyrek, Walzbachtal (DE); Tim Michel, Karlsruhe (DE)

(73) Assignee: Karlsruher Institut für Technologie, Karlsruhe (DE)

(21) Appl. No.: 19/124,114

(22) PCT Filed: Oct. 24, 2023
(86) PCT No.: PCT/EP2023/079647

§ 371 Date: Apr. 24, 2025

(30) Foreign Application Priority Data
Oct. 25, 2022 (DE) 10 2022 211 300.4

(51) Int. Cl. H01M 4/62; H01M 4/36; H01M 10/0525

(52) U.S. Cl. CPC H01M 4/622; H01M 4/366; H01M 10/0525

(57) ABSTRACT

The invention relates to a method (110) for producing a cathode (112), a cathode (112) which is produced using this method, and a battery which comprises such a cathode (112). The method (110) comprises the following steps: a) providing a current collector (114), wherein at least its surface (116) comprises an electrically conductive material (118); b) coating the surface (116) of the current collector (114) with a carbon-containing layer (120); and c) applying an active cathode material (124) to the carbon-containing layer layer (120), the carbon-containing layer layer (120) comprising more than 60 wt. % and less than 80 wt. % carbon and at least one polymer as a binder, and wherein at least step b) is carried out at a temperature of at least 30° C. to at most 70° C.

### FIELD OF THE INVENTION

The present invention relates to a method for producing a cathode, to a cathode and to a battery comprising such a cathode.

### PRIOR ART

For applications in the automotive industry, especially for electrically driven vehicles and as stationary storage means, energy storage means with a long service life and maximum energy and power density are desirable. It is increasingly the case that high energy densities are being achieved using nickel-rich active cathode material composed of lithium-nickel-manganese-cobalt oxide (NMC). Graphite anodes or silicon-based anode material are frequently used on the anode side. These electrode materials are applied by means of a coating process, in particular slot die coating or a slip casting method, in the form of a slip, to a typically thin metallic made of aluminum foil, which serves as a current collector.

Conventional slips for electrode production include water-based processing for coating of the anodes and processing based on N-methyl-2-pyrrolidone (NMP) for coating of the cathodes. The solids content is typically 40% by weight to 60% by weight for the anode slips used and 50% by weight to 70% by weight for the cathode slips used, depending in each case on the active cathode material chosen, on the weight ratios between the active cathode material, the carbon additives and the binder, and on the physicochemical properties of the active cathode material, in particular the particle shape, particle size, particle size distribution and molecular weight thereof. In the case of extrusion, solids contents of up to 90% may also be attained. Even though the mixing process on an industrial scale is generally not known to the public, it is common knowledge that the complex mechanisms and process steps of the slip mixture, particularly with regard to wetting, dispersion and stabilization, have a considerable effect on the quality and stability of the finished electrodes and of batteries comprising such electrodes. Particularly for highly viscous slips with a high solids content, the choice of composition, of binders, of particle sizes, of particle shapes and, where present, of additives is crucial in order to obtain uniform and reproducible layers of active cathode material that meet the high quality demands of lithium-ion batteries.

Both for reasons of cost and environmental reasons, particularly with regard to current and/or expected government legislation, the use of organic solvents, in particular of N-methyl-2-pyrrolidone (NMP), in cathode slips will be dispensed with in the future. On the other hand, according to the currently known state of the art, it is a major technical challenge to produce NMP-free cathode slips. Because of the strong interaction of nickel-rich NMC cathode powder with water, the stability of the slips is reduced; in particular, because of the high pH set of pH≈12, corrosion of the aluminum current collector set in. The corrosion of the aluminum current collector proceeds in the pH range above pH>9 and is associated with the formation of gaseous hydrogen, which can easily lead to damage to the surface of the aluminum current collector, particularly as a result of pore formation, cracking or layer detachment. A known measure to counteract such damage to the surface of the aluminum current collector is to add an acid in order in this way to reduce the pH typically to 7 to 11, preferably to 8 to 10, in particular to 9±0.5. However, the addition of acid may have an adverse effect on the rheology of the cathode slip, of the electrode conductivity or layer adhesion thereof. Overall, the addition of acid can result in the observation of increased cell degradation. Depending on the type of acid, reaction layers can also form on particles of the active cathode material, which can cause an increase in cell resistance and can lead overall to decreased performance of the electrochemical cell. Alternatively or additionally, the active cathode material can be coated, in particular by means of an artificial solid electrolyte interphase (SEI), e.g. by coating with ZrO₂, in order to prevent the water from reacting with the active cathode material, in order to thus avoid the rise in pH.

DE 10 2011 077 932 A1 discloses a cathode unit for an alkali metal-sulfur battery containing a cathode collector comprising a carbon substrate, and an electrochemically active component which is selected from sulfur or an alkali metal sulfide and is in electrically conductive contact with the carbon substrate.

DE 102 51 241 A1 discloses a method of producing Li-polymer batteries by means of a composite system comprising a collector, electrode compositions and separator, wherein collector films to which pasty electrode compositions have been applied are then joined together with separator material in such a way that the electrode substrate side to which the electrode composition has been applied is contacted with the separator material. This process leads to Li-polymer batteries with smooth structures without surface roughness, improved cycle stability, long-term stability and suppression of troublesome side reactions.

EP 1 609 878 A1 discloses a carbon-coated aluminum material that can improve the adhesion between an aluminum material and an active substance layer, and a production process. The carbon-coated aluminum material comprises an aluminum material and a carbonaceous layer formed on the surface of the aluminum material, and also includes an interlayer that has been formed between the aluminum material and the carbonaceous layer and contains aluminum and carbon. The production process for a carbon-coated aluminum material comprises a step of arranging an aluminum material in a space containing a hydrocarbonaceous substance, and a step of heating in the state in which the aluminum material is arranged in the space containing the hydrocarbonaceous substance.

DE 10 2014 220 964 A1 discloses a method of producing an electrode for a lithium-containing battery or a capacitor, comprising providing a graphite material containing at least one electrically conductive carbon material, providing an active material mixture containing electrochemically active material; feeding the graphite material and the active material mixture into a calender apparatus such that a concentration gradient of the electrically conductive carbon material is established over a gap width and a gap height, and forming the supplied materials in the calender apparatus to a film at least comprising an electrically conductive carbon substrate and a layer containing the active material mixture.

WO 2017/001118 A1 discloses an anode for a lithium cell. In order to increase coulombic efficiency and/or cycling stability of the lithium cell, the lithium cell comprises a porous silicon monolith with a graphite coating. The invention further relates to a production process, to a lithium cell and to a lithium battery.

### OBJECTIVE OF THE INVENTION

On that basis, it is the objective of the present invention to provide a method of producing a cathode, a cathode and a battery comprising such a cathode which at least partly overcome the known disadvantages and limitations of the prior art.

The method and cathode are intended in particular to enable avoidance of addition of acid, in order to avoid damage to the surface of the aluminum current collector in the cathode, typically as a result of pore formation, cracking or layer detachment, or other adverse effects on the rheology of the cathode slip or on the electrode conductivity and layer adhesion that can lead overall to elevated cell degradation, in order to be able to dispense with complex modification of the current collector and/or the active cathode material by means of additional physical coating processes, and it would be desirable for the specific capacity of a cathode produced by this method not to deteriorate compared to the cathodes known from the prior art.

### DISCLOSURE OF THE INVENTION

This objective is achieved by a method of producing a cathode, a cathode and a battery comprising such a cathode according to the features of the independent claims. Advantageous developments, which are implementable individually or in any desired combination, are described in the description that follows and in the dependent claims.

In a first aspect, the present invention relates to a method of producing a cathode, wherein the cathode has at least a current collector and an active cathode material. The term “cathode” refers to an electrode, i.e. a body which can be subjected to an electrical voltage and/or an electrical current and which undergoes a reduction process during a process of discharging a battery, i.e. generally a reduction in an oxidation state of a transition metal cation in the active cathode material. By contrast, the term “anode” refers to a further electrode in which an oxidation process proceeds during the process of discharging the battery. It is also a convention that, during a battery charging process, the names “cathode” and “anode” are retained, even though the reduction process and the oxidation process are performed in reverse. In addition, the term “battery” refers to an electrochemical cell which has at least one cathode, at least one anode electrically isolated therefrom and at least one electrolyte set up for exchange of electrical charge; further components, e.g. electrical connections and/or a separator, are possible.

The present method of producing a cathode comprises steps a) to c) that are described in detail hereinafter, where all steps a) to c) can be performed preferably successively in the sequence specified, beginning with step a), followed firstly by step b) and then step c). Alternatively, at least two of the specified steps may also proceed partly simultaneously, in particular in a continuous process in which step c) is effected on sections of the cathode on which step b) has already been performed, while step b) is performed simultaneously on other sections of the cathode and step a) is performed on yet other sections of the cathode.

The individual steps of the present method are:
a) providing a current collector, wherein at least the surface thereof includes an electrically conductive material;
b) coating the surface of the current collector with a carbonaceous layer; and
c) applying an active cathode material to the carbonaceous layer,
   wherein the carbonaceous layer comprises more than 60% by weight and less than 80% by weight of carbon and at least one polymer as a binder, and wherein at least step b) is performed at a temperature of at least 30° C. to at most 70° C.

According to step a) of the present method, a current collector is provided. The term “current collector” refers to a portion of the cathode set up to deliver an electrical voltage and/or electrical current generated by the cathode to an external electrically conductive element, in particular to at least one electrical terminal. For this purpose, at least the surface of the current collector, preferably the entire body of the current collector, includes an electrically conductive material. In a particularly preferred configuration, at least the surface of the current collector, preferably the entire body of the current collector, includes aluminum; nickel; at least one precious metal, in particular gold or platinum, or 100% carbon, where aluminum is particularly preferred. However, it is possible to use thin layers of these materials or other materials, preferably ceramic, including Al₂O₃, or a semiconductor such as Si, preferably in doped form, on any desired substrates.

According to step b) of the present method, the electrically conductive surface of the current collector is coated with a carbonaceous layer. The term “coating” refers here to an operation by which at least one material is applied to a substrate in such a way that a layer is created on the substrate as a result. The term “layer” relates here to an arrangement in which a two-dimensional extent of the layer exceeds a layer thickness of the layer by a factor of at least 5, preferably of at least 10, more preferably of at least 50.

The term “carbonaceous layer” refers here to a layer having a composition that includes a detectable proportion of carbon (C), preferably a predominant proportion of carbon (C). According to the invention, the carbonaceous layer comprises more than 60% by weight, preferably at least 65% by weight, more preferably at least 67.5% by weight, and less than 80% by weight, of carbon, preferably not more than 75% by weight, preferably not more than 72.5% by weight, in particular about 70% by weight, of carbon, and at least one polymer as a binder, wherein the proportions of carbon and polymer in the carbonaceous layer more preferably add up to 100% by weight. The carbon used is preferably carbon black, where the term “carbon black” refers to a black pulverulent solid comprising at least 80% by weight and at most 99.5% by weight of carbon. In principle, however, it is also conceivable to use at least one other type of carbon, in particular conductive carbon black, which can have particle sizes of up to a few 100 nm; conductive graphite, e.g. KS6L, which has particle sizes in the μm range or in the sub-μm range; amorphous carbon, including soft carbon or hard carbon; and/or carbon polymorphs that include an impurity, for example in the form of heteroatoms.

“Binder” or “binding agent” refers to substances designed to produce a composite in the form of an essentially physical compound by means of adhesion, cohesion and/or adsorption between particles and/or phase boundaries, whereby the particles or the regions delimited by phase boundaries in the composite are adsorbed to one another such that they are cohesive, networked or bonded. According to the invention, the binder comprised by the carbonaceous layer includes at least one polymer. The term “polymer” refers here to a chemical compound comprising a plurality of molecules arranged alongside one another, of the same or a similar type and referred to as “monomers”. In a particularly preferred configuration, the at least one polymer encompassed by the binder is selected from: polyvinylidene fluoride (PVDF); polyamide (PA); polybutylacrylate (PBA); polyacrylic acid (PAA); poly(methylacrylate) (PMA); a cellulose, preferably carboxymethylcellulose (CMC), in particular Na-CMC or succinoyl-carboxymethylcellulose (SCMC); a styrene-butadiene rubber (SBR), a mixture of SBR+SCMC; an epoxy-based binder, in particular an epoxy hardener system; a latex hydride polymer; a biopolymer, preferably a polysaccharide-based plant gum, in particular alginate, guar flour, karaya or xanthan. However, the use of at least one other polymer is conceivable.

According to the invention, the composition of the carbonaceous layer is thus adjusted in the specified narrow parameter range. An excessively high proportion of carbon (C), in particular carbon black, as a result of leaching of the carbon component that typically occurs, in particular of the carbon black, out of the composite composed of the carbon and the binder, would not sufficiently prevent to corrosion of the surface of the current collector, in particular of the electrically conductive electrode material on the surface of the current collector, more preferably of the aluminum in the subsequent application of the active cathode material to the carbonaceous layer in step c). This effect was able to be confirmed by preliminary tests on commercially available graphite-coated current collectors made of aluminum. In addition, it was possible to observe that, in the case of a very high proportion of carbon (C), in particular carbon black, pores form in the carbonaceous layer, which can expose the current collector in such a way that the current collector would no longer be protected from corrosion. Too small a proportion of carbon (C), in particular carbon black, would firstly worsen electrical contacting of the cathode with the current collector, and secondly, as was able to be actuated by corresponding tests, hydrophobic wetting behavior of the cathode slip would be established, which would make it considerably more difficult or impossible to achieve very substantially homogeneous coating of the carbonaceous layer. For further details, reference is made in this regard to the description of the exemplary examples that follows.

In addition, the surface of the current collector is coated with the carbonaceous layer in step b) in accordance with the invention at a temperature of at least 30° C., preferably of at least 35° C., more preferably of at least 40° C., up to at most 70° C., preferably up to at most 65° C., more preferably up to at most 60° C. For this purpose, the surface of the current collector is coated with the carbonaceous layer by means of a coating method, where the coating method is preferably selected from a squeegee method, spraying method, slot-die coating, extrusion method, spin-coating or printing method, in particular aerosol jet printing); however, the use of a different type of coating methods is conceivable. The preferred coating methods are in particular simple methods that can be performed inexpensively; the use of complex and costly coating methods, in particular physical vapor deposition (PVD) or atomic layer deposition (ALD), can be dispensed with.

The carbonaceous layer of the invention can thus act in particular as a passivating layer. The term “passivating layer” refers here to a layer which can sufficiently prevent the corrosion of the surface of the current collector, more preferably of the aluminum, during the applying of the active cathode material to the carbonaceous layer.

The carbonaceous layer of the invention may have a layer thickness of at least 0.1 μm, preferably of at least 0.25 μm, more preferably of at least 0.5 μm, and of at most 20 μm, preferably at most 10 μm, more preferably of at most 7.5 μm. For further details in this regard, reference is made to the description of the exemplary examples that follows.

According to the invention, in addition to adjusting the composition of the carbonaceous layer in the specified narrow parameter range, the carbonaceous layer is thus also produced in the further specified narrow parameter range. For this purpose, it could be shown experimentally that drying of the carbonaceous layer, which can proceed very quickly due to a very small layer thickness, should not be effected at a temperature of 70° C. or higher since, in this temperature range, texturing of the carbonaceous layer in the microscale and/or nanoscale range changes, by comparison with drying at a temperature in the selected temperature range, in such a way that hydrophobic wetting behavior or even superhydrophobic wetting behavior, characterized by the occurrence of what is called the “lotus effect”, is established for a layer applied thereto. For further details, reference is made in this regard to the description of the exemplary examples that follows.

According to step c) of the present method, an active cathode material is applied to the carbonaceous layer. The term “applying” refers here to an operation by which at least one material is applied to a substrate in such a way that the material remains on the substrate as a result. The cathode material may include lithium-containing materials or materials having at least one other cation, preferably sodium. The lithium-containing materials may preferably be selected from lithium-nickel-manganese oxide (LiNi_{0.5}Mn_{1.5}O₄, LNMO); a mixture of LNMO with an additional compound selected from at least one of the elements Co, Al and additional Li; lithium-rich NMC (x LiMn₂O₃·NMC); a lithium-nickel-manganese-cobalt oxide (LiNiₓMn_{y}Co_{z}O₂, NMC) and a lithium-rich lithium-nickel-manganese-cobalt oxide (x LiMn₂O₃·NMC, x≤0.4); lithium metal phosphate (LiMPO4), where M is selected from at least one of the elements Fe, Mn, Co or Ni, in particular lithium iron phosphate (LiFePO₄, LFP), lithium manganese phosphate (LiMnPO₄), lithium cobalt phosphate (LiCoPO₄, LCP) and lithium nickel phosphate (LiNiPO₄); lithium cobalt oxide (LiCoO₂, LCO); lithium manganese oxide (LiMn₂O₄ or Li₂MnO₃, LMO); or lithium-nickel-cobalt-aluminum oxide (LiNi_{1-x-y}CoₓAl_{y}O₂, NCA). In addition, the cathode material may include other types of lithium- or sodium-containing materials. Moreover, a combination of at least two cathode materials may also be suitable.

In a particularly preferred configuration, the active cathode material can be applied to the carbonaceous layer in step c) by
c1) applying an aqueous cathode slip to the carbonaceous layer; and
c2) drying the aqueous cathode slip on the carbonaceous layer.

The aqueous cathode slip here may preferably comprise an aqueous solution of the active cathode material.

The term “cathode slip” refers generally to a mixture of the active cathode material, at least one binder, optionally of additives, in particular of conductive carbon black or conductive graphite, and at least one solvent. The preferred use of water as a solvent—by contrast with the methods known from the prior art—more preferably makes it possible to dispense with the use of an acid, as a result of which, firstly, the current collector can be better protected against corrosion and, secondly, there is no decrease in the electrical capacity of a battery comprising at least one cathode that has been produced by the present method.

The aqueous cathode slip, in step c1), can be applied to the carbonaceous layer by means of a coating method. More preferably, the coating method used for this purpose may be the same as that which is also used for coating of the surface of the current collector with the carbonaceous layer in step b). The coating method may preferably be selected from one of the abovementioned coating methods; however, the use of another type of coating methods is conceivable.

After step c1) or else even during the performance of step c1), the aqueous cathode slip on the carbonaceous layer can be dried in step c2). The drying can be effected here passively or actively, where active drying can be accomplished using a drying method selected from radiative drying, in particular by means of laser radiation or infrared radiation; or convection drying, in particular by means of a flotation dryer. For the drying of the aqueous cathode slip during step c2), in a particular configuration, it is possible to use at least one temperature ramp and/or at least one temperature zone.

During step c), the temperature used may preferably be the same as that which is also used during the coating of the surface of the current collector with the carbonaceous layer in step b); however, the use of a lower temperature or a higher temperature is possible. Step c), in particular step c2), in a particular configuration, can therefore also be effected at a lower temperature, preferably even at room temperature, i.e. from 15° C. to 25° C., in particular at about 20° C., or else, after completion of step b), at a temperature above 70° C., in particular even above 100° C., but below a glass transition temperature of the polymer used as binder and below a critical temperature at which a phase transition or a change in state of matter occurs in the active cathode material, the binder, optionally the additive, in particular the conductive carbon black or conductive graphite, that are encompassed by the cathode slip used in each case.

As apparent in detail in particular from the exemplary examples shown below, the selected composition of the carbonaceous layer in a narrow parameter range and the manner of production of the carbonaceous layer within a narrow temperature range have the effect that the layer of the active cathode material is more preferably formed as a homogeneous layer on the surface of the carbonaceous layer. The term “homogeneous” refers here to a layer having a composition and spatial phase that are largely independent of the location in the layer, especially below a respectively chosen threshold value. The creation of a homogeneous layer from the active cathode material is promoted in particular in that the carbonaceous layer shows such wetting behavior that enables homogeneous coating; hydrophobic wetting behavior or even superhydrophobic wetting behavior is ruled out. For further details in this regard, reference is made to the description of the exemplary examples that follows.

In a particularly preferred configuration, the applying of the active cathode material to the carbonaceous layer in step c) may additionally comprise the following step:
c3) subsequently calendering the at least partially dried active cathode material on the carbonaceous layer.

In particular, the use of a calendering method that can follow after the applying of the aqueous cathode slip to the carbonaceous layer and after at least partial, preferably complete, drying of the aqueous cathode slip on the carbonaceous layer allows, as set out in detail below in the description of the exemplary examples, embedding or indenting of particles of the active cathode material into the carbonaceous layer. Such an operation can particularly advantageously be associated with an increase in a mechanical and/or electrical attachment of the active cathode material to the current collector. In this way, it is firstly possible to increase adhesion between the layer of the active cathode material and the current collector because of the presence of the carbonaceous layer in the cathode, and secondly to reduce electrical transfer resistance between the layer of the active cathode material and the current collector, likewise because of the presence of the carbonaceous layer in the cathode. However, other advantages are conceivable.

In a further aspect, the present invention relates to a cathode that has preferably been produced by the method disclosed herein. Here, the cathode comprises
a current collector, the surface of which includes an electrically conductive material;
a carbonaceous layer on the surface of the current collector; and
an active cathode material on the carbonaceous layer,
   wherein the carbonaceous layer comprises more than 60% by weight and less than 80% by weight of carbon and at least one polymer as a binder, and wherein the layer of the active cathode material is formed as a homogeneous layer on the surface of the carbonaceous layer. With regard to the term “homogeneous”, reference is made to the above definition of this term.

In a further aspect, the present invention relates to a battery comprising at least
at least one cathode produced by the process disclosed herein;
at least one anode; and
at least one electrolyte.

In addition, the battery may comprise at least one further component, in particular a separator for the spatial separation of the at least one cathode from the at least one anode. The battery may thus especially be a lithium ion battery, lithium-polymer battery or what is called a post-lithium battery, preferably a sodium battery. In addition, other kinds of batteries or energy storage media are conceivable, especially solid-state batteries, including hybrid polymer-ceramic solid-state batteries, or supercapacitors.

The at least one anode here may comprise at least one anode material, where the anode material may preferably be selected from graphite, amorphous carbon, including soft carbon or hard carbon; silicon, silicon oxide, a silicon/graphite composite, a silicon oxide/carbon composite, a silicon/carbon composite material, metallic lithium, lithium titanate, an alloy of lithium comprising at least one of the elements tin, germanium, magnesium, aluminum and zinc, or a transition metal-doped zinc oxide or tin oxide, tin, germanium, magnesium, aluminum or zinc; however, the use of another anode material or a combination of at least two cathode materials is possible.

For further details both in relation to the cathode and to the battery, reference is made to the description of the method disclosed herein and to the exemplary examples.

The method of producing a cathode, the cathode and the battery comprising such a cathode, which method is disclosed herein, have a number of advantages over cathodes, methods of producing cathodes and batteries comprising such cathodes that are known from the prior art. In particular, there is no need to add an acid in the production of the cathode, and in this way damage to the surface of the aluminum current collector in the cathode, typically as a result of pore formation, cracking or layer detachment, and it is possible to avoid further disadvantages, in particular relating to the rheology of the cathode slip or to the electrode conductivity and the layer adhesion, which overall can cause increased cell degradation. Furthermore, it is possible to dispense with complex modification of the current collector and/or the active material by means of additional physical coating processes. Finally, the specific capacity of a cathode produced by the present method may remain unchanged compared to the cathodes known from the prior art or may even improve in a surprising manner.

The words “have,” “include”, “contain” or “comprise”, or any grammatical variants thereof, will be used herein in a non-exclusive manner. Accordingly, these words can relate both to situations in which no further features in addition to the features introduced by those words are present, and to situations in which one or more further features are present. For example, the expression “A has B”, “A includes B”, “A contains B” or “A comprises B” can relate both to the situation in which, apart from B, no further element is present in A (i.e. to a situation in which A consists exclusively of B), and to the situation in which, in addition to B, one or more further elements are present in A, for example element C, elements C and D, or even further elements.

It is also pointed out that the expressions “at least one” and “one or more” and grammatical variants of these expressions, when said expressions are used in connection with one or more elements or features and are intended to express that the element or feature may be provided once or multiple times, are generally only used once, for example upon the first introduction of the feature or element. If the feature or element is subsequently mentioned again, the corresponding term “at least one” or “one or more” is generally not used again, without thereby limiting the possibility that the feature or element may be provided once or more than once.

Furthermore, the words “preferably”, “in particular”, “for example”, or similar words are used herein in connection with optional features without alternative embodiments being limited hereby. For instance, features which are introduced by these words are optional features, and there is no intention of limiting the scope of protection of the claims and in particular of the independent claims by these features. For instance, the invention, as will be seen by a person skilled in the art, can also be performed using different configurations. Similarly, features introduced by way of “in one embodiment of the invention” or by way of “in a exemplary example of the invention” are regarded as optional features, without any intention to limit alternative configurations or the scope of protection of the independent claims thereby. Furthermore, these introductory expressions are not intended to affect all the ways in which the features introduced thereby can be combined with other features, be they optional or non-optional features.

### BRIEF DESCRIPTION OF THE FIGURES

Further details and features of the present invention are apparent from the following description of preferred exemplary examples, in particular in connection with the dependent claims. In this context, the respective features can be implemented on their own, or a plurality thereof can be implemented together in combination. However, the invention is not limited to the exemplary examples. The exemplary examples are illustrated schematically in the figures that follow. Identical reference numerals in the figures refer to identical or functionally identical elements or to elements which correspond to one another in terms of their functions. The figures show:

FIG. 1 a schematic diagram of a preferred embodiment of the steps of the method of the invention for producing a cathode with drawings in cross-sectional view;

FIG. 2 a schematic diagram of the adjustment of the invention both for the composition of the carbonaceous layer over a parameter range (FIG. 2a) and the production of the carbonaceous layer over a temperature range (FIG. 2b);

FIG. 3 a schematic diagram of a cathode of the invention in cross-sectional view;

FIG. 4 a comparison of the progression of the specific capacity of NMC-622 half cells as a function of the number of cycles for different C rates, produced by means of a water-based slip with and without addition of acid; and

FIG. 5 diagram of cyclic voltammograms for a exemplary example with a carbonaceous layer for a comparative example without a carbonaceous layer.

### DESCRIPTION OF THE EXEMPLARY EXAMPLES

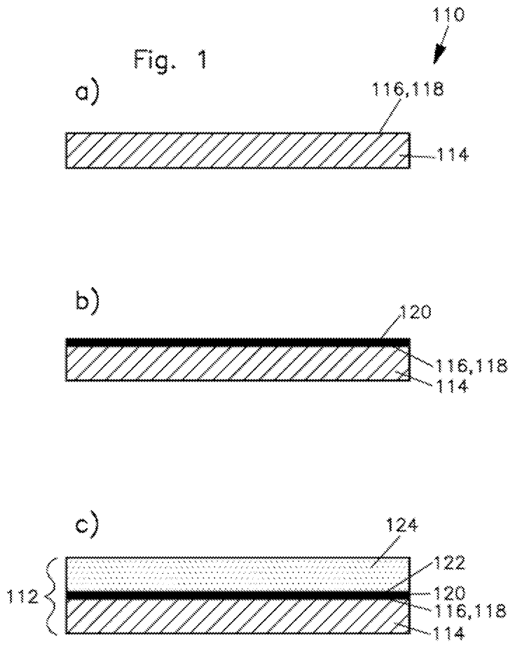

FIG. 1 shows, in cross-sectional view in each case, a schematic diagram of a preferred embodiment of steps a) to c) of the method 110 of the invention for producing a cathode 112.

According to step a) of the present method 110, a current collector 114 is provided, wherein at least the surface 116 thereof includes an electrically conductive material 118. Preferably, at least the surface 116 of the current collector 114, preferably the whole body of the current collector 114, includes aluminum; but the use of a different electrically conductive material 118 is possible.

According to step b) of the present method 110, especially after step a), the surface 116 of the current collector 114 is coated with a carbonaceous layer 120. According to the invention, the carbonaceous layer comprises more than 60% by weight, preferably at least 65% by weight, more preferably at least 67.5% by weight, and less than 80% by weight, of carbon, preferably not more than 75% by weight, preferably not more than 72.5% by weight, in particular about 70% by weight, of carbon, and at least one polymer as a binder, wherein the proportions of carbon and polymer in the carbonaceous layer more preferably add up to 100% by weight. The carbon used is preferably carbon black.

According to step c) of the present method 110, especially after step b) or else even during the performance of step b), an active cathode material 124 is applied to the surface 122 of the carbonaceous layer 120. Step c) here may preferably comprise
applying an aqueous cathode slip comprising an aqueous solution of the active cathode material 124 in step c1) to the surface 122 of the carbonaceous layer 120; and
drying the aqueous cathode slip in step c2) on the surface 122 of the carbonaceous layer 120, wherein this may be followed by
calendering the at least partly dried active cathode material 124 on the surface 122 of the carbonaceous layer 120 in step c3).

Optional calendering of the at least partly dried active cathode material 124 on the surface 122 of the carbonaceous layer 120 in step c3) that follows the applying of the active cathode material 124 to the carbonaceous layer 120, as described below for FIG. 3, can lead both to improved adhesion between the layer of the active cathode material 124 and the current collector 114 and to an improvement in the electrical conductivity and to a reduction in electrical transfer resistance between the layer of the active cathode material 124 and the current collector 114 as a result of the presence of the carbonaceous layer 120 in the cathode 112.

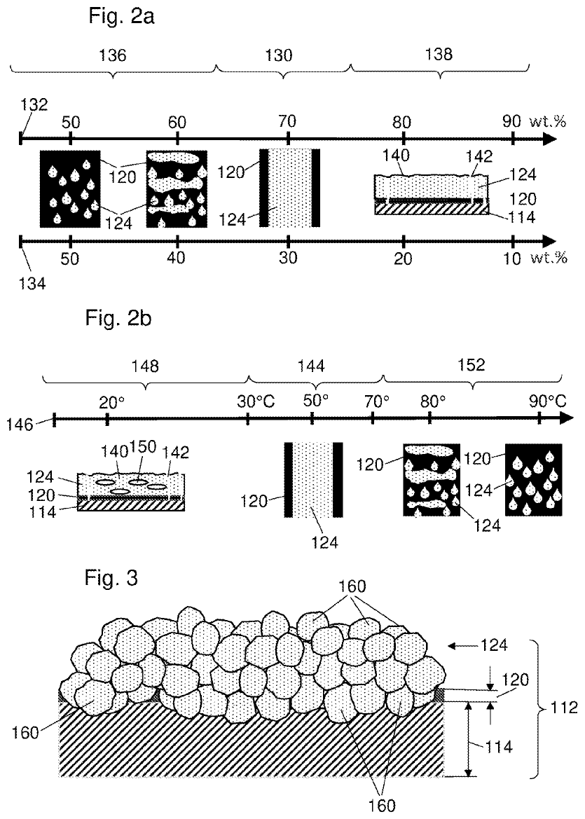

According to the invention, step b) is performed at a temperature of at least 30° C., preferably of at least 35° C., more preferably of at least 40° C., up to at most 70° C., preferably up to at most 65° C., more preferably up to at most 60° C., in particular at about 50° C. For step c), it is possible to use the same temperature or, as described in detail above, even a lower or higher temperature. As apparent in detail from FIGS. 2a and 2b in particular, the selected composition of the carbonaceous layer 120 in a narrow parameter range and the manner of production of the carbonaceous layer 120 within the specified narrow temperature range have the effect that the layer of the active cathode material 124 is formed as a homogeneous layer on the surface 122 of the carbonaceous layer 120.

The carbonaceous layer 120 of the invention may have a layer thickness of at least 0.1 μm, preferably of at least 0.25 μm, more preferably of at least 0.5 μm, and of at most 20 μm, preferably at most 10 μm, more preferably of at most 7.5 μm. In the exemplary examples described below, a layer thickness of 0.5 μm up to 6 μm was used for the carbonaceous layer. This small layer thickness of the carbonaceous layer 120 of the invention means that it typically accounts for at most 1% by weight, preferably at most 0.5% by weight, more preferably at most 0.25% by weight, of a total weight of the cathode 112 and therefore increases neither the total weight nor the material costs of the cathode 112. The carbonaceous layer 120 can act in particular as a passivating layer in that it can sufficiently prevent the corrosion of the surface 116 of the current collector 114, which includes aluminum in particular, during the applying of the active cathode material 124 to the surface 122 of the carbonaceous layer 120.

FIG. 2 shows variations in the shape of the layer of the active cathode material 124 on the surface 122 of the carbonaceous layer 120 depending on the composition of the carbonaceous layer 120 (FIG. 2a) or depending on the manner of production of the carbonaceous layer 120 (FIG. 2b).

As can be seen from FIG. 2a, the desired homogeneous layer of the active cathode material 124 is formed on the surface 122 of the carbonaceous layer 120 only within a parameter range 130, in which the carbonaceous layer 120 has
a proportion 132 of carbon of more than 60% by weight and less than 80% by weight, and
a proportion 134 of binder of at least 20% by weight and at most 40% by weight,
   such that the proportions 132, 134 here add up to 100% by weight in each case. The binder used here by way of example was the polymer polyvinylidene fluoride (PVDF); however, the use of one or more other polymers is possible.

In a further parameter range 136 which is shown in FIG. 2a and in which the carbonaceous layer 120 has
a proportion 132 of carbon of less than 60% by weight, and
a proportion 134 of binder of at least 40% by weight,
   such that the proportions 132, 134 here too add up to 100% by weight in each case, hydrophobic wetting behavior or even superhydrophobic wetting behavior is established on the surface 122 of the carbonaceous layer 120, which has the effect that the layer of the active cathode material 124 is not in the form of the desired homogeneous layer, but in the form of undesirable droplets on the surface 122 of the carbonaceous layer 120.

In a yet further parameter range 138 which is likewise shown in FIG. 2a and in which the carbonaceous layer 120 has
a proportion 132 of carbon of at least 80% by weight, and
a proportion 134 of binder of at most 20% by weight,
   such that the proportions 132, 134 here too add up to 100% by weight in each case, craters or wells 140 and/or capillaries 142 are formed in the volume of the layer of the active cathode material 124, and these extend to the surface 122 of the carbonaceous layer 120 or even to the surface 116 of the current collector 114. As a result of these effects, the surface 116 of the current collector 114, which includes aluminum in particular, is undesirably no longer protected from corrosion.

As can be seen from FIG. 2b, the desired homogeneous layer of the active cathode material 124 is formed on the surface 122 of the carbonaceous layer 120 only within a temperature range 144 in which the surface 116 of the current collector 114 is coated with the carbonaceous layer 120 at a temperature 146 of at least 30° C. to at most 70° C.

In a further temperature range 148 which is shown in FIG. 2b and includes a temperature below 30° C., craters or wells 140 and/or capillaries 142 are formed in the volume of the layer of the active cathode material 124, and these extend up to the surface 122 of the carbonaceous layer 120 or even up to the surface 116 of the current collector 114, and/or pores 150 are formed, such that the surface 116 of the current collector 114, which includes aluminum in particular, here too is no longer protected from corrosion as a result of these effects.

In a yet further temperature range 152 which is likewise shown in FIG. 2b and includes a temperature above 70° C., essentially the same effects as in the parameter range 136 occur, meaning that hydrophobic wetting behavior or even superhydrophobic wetting behavior occurs here too on the surface 122 of the carbonaceous layer 120, which has the effect that the layer of the active cathode material 124 is not in the form of the desired homogeneous layer, but in the form of undesirable droplets on the surface 122 of the carbonaceous layer 120.

FIG. 3 shows a schematic diagram of the cathode 112 of the invention in cross-sectional view. It can be clearly seen herein how particles 160 of the active cathode material 124 are embedded or indented into the carbonaceous layer 120, in particular in order to improve mechanical and electrical contact with the current collector 114 in this way.

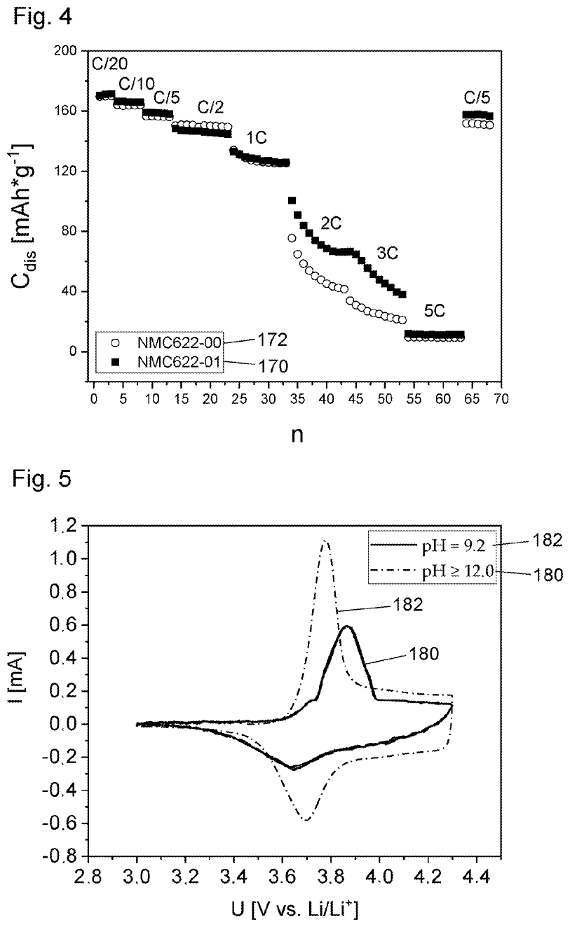

FIG. 4 shows a comparison of the progressions 170, 172 of the specific discharge capacity C_{dis} in mAh/g of NMC622 half-cells as a function of the number of cycles n for different C rates of >0 to <70. NMC622-00 refers here to a comparative sample not covered by the present invention with a the active cathode material 124 lithium-nickel-manganese-cobalt oxide (LiNiₓMn_{y}Co_{z}O₂), NMC) that has been treated with phosphoric acid (H₃PO₄) during the production of the cathode 112 and has a layer thickness of 70 μm, while NMC622-01 denotes a sample of the invention with a the active cathode material 124 NMC that has not been treated with acid and has a layer thickness of 65 μm. NMC622 refers here to Li(Ni_{0.6}MnCo_{0.2})O₂. The comparison of the progression 170 of the specific discharge capacity of the sample of the invention NMC622-01 with the progression 172 of the specific discharge capacity of the comparative sample NMC622-00, surprisingly, actually shows an increase in the specific discharge capacity in the sample of the invention compared to the comparative sample, especially above 1 C.

FIG. 5 shows a diagram of a cyclic voltammogram 180 for a exemplary example with a sample of the invention comprising a carbonaceous layer 120, and a further cyclic voltammogram 182 for a comparative sample not covered by the present invention without a carbonaceous layer, produced with addition of acid. The sample of the invention was produced using an acid-free water-based NMC622 slip, while the comparative sample was produced using a water-based NMC622 slip with addition of acid. The acid-free slip here comprises a slip to which no proportion of acid has been added in order to influence the pH. Reaction of NMC with water establishes a high pH, which can be in the region of 12 or higher. Without acid, this high pH is maintained; with acid, the pH can be reduced, typically to a pH of 7 to 11, preferably of 8 to 10, in particular of 9±0.5, in the present comparative example.

The active cathode materials 124 NMC622 used are from the same batch for both measurements. The comparison of the cyclic voltammogram 180 for the sample of the invention with the cyclic voltammogram 182 for the comparative sample, which is available at https://doi.org/10.3390/nanol1071840, shows that the redox peaks occur at 3.9 V and 3.6 V in the comparative sample, while for the sample of the invention the redox peaks are much closer together at 3.78 and 3.71 V, which indicates distinctly lower cell polarization. Elevated cell polarization when the water-based slip with addition of acid is used may be attributable to a chemical reaction of the acid with the active cathode material 124 and a consequent increase in the electrical transfer resistance between the layer of the active cathode material 124 and the current collector 114. In addition, higher electrical conductivity can be achieved thereby in deep regions close to the current collector, which can be advantageous particularly for high layer thicknesses. Further advantages are detailed above.

### LIST OF REFERENCE NUMERALS

110 method of producing a cathode
112 cathode
114 current collector
116 surface
118 electrically conductive material
120 carbonaceous layer
122 surface
124 active cathode material
130 parameter range
132 proportion of carbon
134 proportion of binder
136 parameter range
138 parameter range
140 crater or well
142 capillary
144 temperature range
146 temperature
148 temperature range
150 pores
152 temperature range
160 particle
170 progression of the specific discharge capacity of the sample of the invention
172 progression of the specific discharge capacity of the comparative sample
180 cyclic voltammogram of the sample of the invention
182 cyclic voltammogram of the comparative sample

1. A method of producing a cathode, wherein the cathode has at least a current collector and an active cathode material, wherein the method comprises the following steps:
a) providing a current collector, wherein at least the surface thereof includes an electrically conductive material;
b) coating the surface of the current collector with a carbonaceous layer; and
c) applying an active cathode material to the carbonaceous layer,
wherein the carbonaceous layer comprises more than 60% by weight and less than 80% by weight of carbon and at least one polymer as a binder, and wherein at least step b) is performed at a temperature of at least 30° C. to at most 70° C.

2. The method of claim 1, wherein the carbonaceous layer comprises carbon black, wherein the carbon black is a black pulverulent solid comprising at least 80% by weight and at most 99.5% by weight of carbon.

3. The method of claim 1, wherein the active cathode material is applied to the carbonaceous layer in step c) by
c1) applying an aqueous cathode slip to the carbonaceous layer; and
c2) drying the aqueous cathode slip on the carbonaceous layer,
wherein the aqueous cathode slip comprises an aqueous solution of the active cathode material.

4. The method of claim 1, wherein the active cathode material takes a form of a homogeneous layer on a surface of the carbonaceous layer.

5. The method of claim 1, wherein the applying of the active cathode material to the carbonaceous layer in step c) comprises:
c3) calendering the at least partially dried active cathode material on the carbonaceous layer.

6. The method of claim 1, wherein at least step b) is performed at a temperature of at least 40° C. to at most 60° C.

7. The method of claim 1, wherein the carbonaceous layer comprises at least 65% by weight and at most 75% by weight of carbon and the binder.

8. The method of claim 1, wherein the coating of the surface of the current collector with the carbonaceous layer in step b) is carried out until the carbonaceous layer has a layer thickness of 0.1 μm to 20 μm.

9. The method of claim 8, wherein the coating of the surface of the current collector with the carbonaceous layer in step b) is carried out until the carbonaceous layer has a layer thickness of 0.1 μm to 10 μm.

10. The method claim 9, wherein the coating of the surface of the current collector with the carbonaceous layer in step b) is carried out until the carbonaceous layer has a layer thickness of 0.1 μm to 7.5 μm.

11. The method of claim 1, wherein at least the surface of the current collector includes aluminum, nickel, a precious metal, carbon, or a thin layer thereof or of a dielectric or of a semiconductor.

12. The method of claim 1, wherein the at least one polymer is selected from polyvinylidene fluoride, polybutylacrylate, polyacrylic acid, styrene-butadiene rubber, a biopolymer or a mixture thereof.

13. The method of claim 1, wherein the active cathode material is selected from a lithium- or sodium-containing material.

14. A cathode, comprising
a current collector the surface of which includes an electrically conductive material;
a carbonaceous layer on the surface of the current collector; and
a layer of an active cathode material on the carbonaceous layer,
wherein the carbonaceous layer comprises more than 60% by weight and less than 80% by weight of carbon and at least one polymer as a binder, and wherein the layer of the active cathode material is formed as a homogeneous layer on the carbonaceous layer.

15. A battery, comprising
at least one cathode of claim 14;
at least one anode; and
at least one electrolyte.
